(19) United States
(12) Patent Application Publication
(10) Pub. No.: US 2024/0047128 A1
(43) Pub. Date: Feb. 8, 2024

(54) Matrix Transformer

(71) Applicant: KOSTAL Automobil Elektrik GmbH & Co. KG, Luedenscheid (DE)

(72) Inventor: Norbert HEES, Dortmund (DE)

(73) Assignee: KOSTAL Automobil Elektrik GmbH & Co. KG, Luedenscheid (DE)

(21) Appl. No.: 18/489,914

(22) Filed: Oct. 19, 2023

Related U.S. Application Data
(63) Continuation of application No. PCT/EP2022/065333, filed on Jun. 7, 2022.

(30) Foreign Application Priority Data
Jun. 17, 2021 (DE) 10 2021 003 119.9

(51) Int. Cl. H01F 27/30; H01F 27/24; H01F 27/22; H01F 27/28; H01F 27/06

(52) U.S. Cl. CPC H01F 27/306; H01F 27/24; H01F 27/22; H01F 27/2823; H01F 27/06; H01F 2027/065

(57) ABSTRACT

A matrix transformer includes a magnetic core structure and windings. The magnetic core structure includes magnetic legs and a pair of spaced-apart magnetic plates that are connected together by the magnetic legs. The windings are wrapped around the magnetic legs and have electric current flow directions which cause magnetic fluxes within the magnetic core structure that cancel out in a middle region of each magnetic plate thereby leaving the middle region of each magnetic plate to be a magnetic field-free zone. A first one of the magnetic plates has a recess extending through its middle region within its magnetic field-free zone. A cooling pin connected to a heat sink is insertable through the recess.

### CROSS-REFERENCE TO RELATED APPLICATIONS

This application is a continuation of International Application No. PCT/EP2022/065333, published in German, with an International filing date of Jun. 7, 2022, which claims priority to DE 10 2021 003 119.9, filed Jun. 17, 2021, the disclosures of which are incorporated in their entirety by reference herein.

### TECHNICAL FIELD

The present invention relates to a matrix transformer including a body, made of a soft magnetic material, and a plurality of electrical current-conductive windings, the body forming a closed magnetic circuit through openings in at least one printed circuit board (PCB), the body having a plurality of magnetic legs that are surrounded by the windings, the body further having two parallel magnetic plates that are on respective sides of the PCB and that are connected to one another by the magnetic legs, and the windings, due to a suitably selected winding direction, each forming at least one magnetic field-free zone in the magnetic plates.

### BACKGROUND

Transformers that are integrated into printed circuit boards (PCBs) are used to achieve flat designs and predictable heat dissipation. These transformers are made of a flat soft magnetic material core structure, preferably ferrite, and windings. The magnetic core structure forms a closed magnetic circuit through openings in a PCB. The windings (i.e., turns), which are formed by strip conductors or conductor tracks on the PCB, surround magnetic legs of the magnetic core structure.

The windings may be established using multiple PCBs instead of just one PCB. Additional winding parts formed by electrical conductors may also be mounted on the PCB. The winding parts may be formed from wound wires or cut sheet metal, for example.

To minimize the number of conductor layers required in the PCB, the windings formed by the strip conductor structures are distributed over multiple magnetic legs. The magnetic legs are arranged in a row and column shaped structure. Through a suitably selected winding direction of the windings respectively around the magnetic legs, this arrangement forms a so-called matrix transformer.

This type of matrix transformer is described in U.S. Pat. No. 4,665,357.

A matrix transformer has the advantage that magnetic fluxes therein partially cancel one another out, and magnetic losses caused by alternating magnetic fields are likewise reduced. The formation of at least one magnetic field-free zone can be achieved by a suitable arrangement of magnetic legs and winding directions.

### SUMMARY

An object is to achieve improved cooling and/or higher electrical power for a matrix transformer.

In embodiments of the present invention, a matrix transformer includes a body, a plurality of windings, and a heat sink having a cooling pin connected thereto. The body is made of a soft magnetic material and forms a closed magnetic circuit through openings in at least one printed circuit board (PCB). The body includes a plurality of magnetic legs and two parallel magnetic plates. The magnetic legs extend through the openings in the PCB and are surrounded by respective ones of the windings. The magnetic plates are positioned over respective sides of the PCB (i.e., top and bottom magnetic plates are positioned over top and bottom sides of the PCB). The magnetic legs connect the magnetic plates to one another. The windings (or turns) are electrical current conductive windings. The windings, owing to a suitably selected winding direction, each form at least one magnetic field-free zone in the magnetic plates. A recess is provided in one of the magnetic plates within the magnetic field-free zone of the one of the magnetic plates (e.g., a recess is provided in the bottom magnetic plate within the magnetic field-free zone of the bottom magnetic plate). The cooling pin is guided through the recess as far as a surface of the PCB.

Embodiments of the present invention achieve the above object and/or other objects in that a recess is introduced into at least one magnetic plate within the magnetic field-free zone, through which recess a cooling pin which is connected to a heat sink is guided up to a surface of the PCB.

A matrix transformer in accordance with embodiments of the present invention is based on the finding that the magnetic field-free zone is not necessary for the functioning of the transformer, so that the magnet material may be saved there, thus providing the option for coupling a heat sink to the transformer.

### BRIEF DESCRIPTION OF THE DRAWINGS

A matrix transformer in accordance with embodiments of the present invention are illustrated and explained in greater detail below with reference to the drawings, which include the following:

FIG. 1 illustrates a sectional view of a matrix transformer;

FIG. 2 illustrates the basic design of the matrix transformer;

FIG. 3 illustrates the flow directions for the matrix transformer; and

FIG. 4 illustrates the design of a magnetic plate of the matrix transformer having an opening for a cooling pin.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

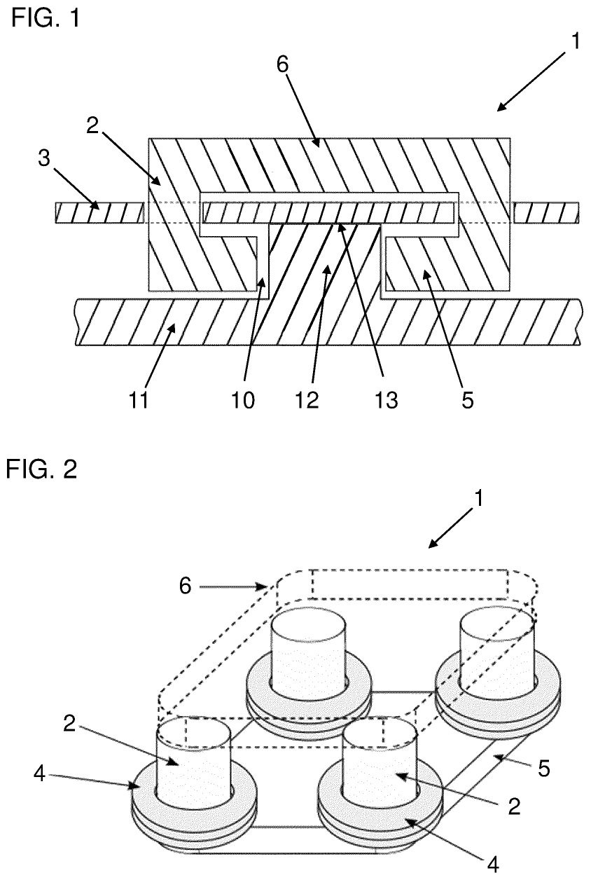

Referring now to FIGS. 1 and 2, a matrix transformer is shown. The matrix transformer includes a magnetic core structure or body 1. Body 1 is made of a soft magnetic material. Body 1 includes a plurality of magnetic legs 2 and a pair of parallel magnetic plates 5, 6. Body 1 forms a closed magnetic circuit through openings in a printed circuit board (PCB) 3. In this regard, magnetic legs 2 extend through respective openings in PCB 3 and magnetic plates 5, 6 are positioned over respective sides of the PCB. Particularly, top magnetic plate 6 is positioned over a top side of PCB 3 and bottom magnetic plate 5 is positioned under a bottom side of PCB 3. Magnetic plates 5, 6 are connected to one another by magnetic legs 2.

The matrix transformer further includes a plurality of electrical current-conductive windings (or turns) 4. Windings 4 surround or wrap around the portions of magnetic legs 2 extending through respective openings in PCB 3. Windings 4, owing to a suitably selected winding direction, each form at least one magnetic field-free zone in magnetic plates 5, 6.

A recess 10 is provided in bottom magnetic plate 5 within the magnetic field-free zone of the bottom magnetic plate.

The matrix transformer further includes a heat sink 11 having a cooling pin 12 connected thereto. Cooling pin 12 is guided through recess 10 as far as a surface of PCB 3.

In further detail, FIG. 1 schematically illustrates the basic design of the matrix transformer. As noted, the transformer is made up of body 1, made of soft magnetic material, that forms a closed magnetic circuit through at least two openings in at least one PCB.

In particular, FIG. 2 shows four cylindrical magnetic legs 2 made of a ferrite material, which are situated next to one another in two rows and two columns, with adjacently situated magnetic legs 2 in each case having the same distance from one another. The bottom and top end faces of magnetic legs 2 are closed off by a magnetic plate 5, 6, respectively. In addition, one or more magnetic legs 2 may be designed in one piece with one of magnetic plates 5, 6.

Multiple windings 4 of an electrical conductor are symbolically illustrated around each of magnetic legs 2. Windings 4 may be formed by strip conductors of a multilayer PCB. The PCB itself is not depicted in FIG. 2 for the sake of clarity of the illustration, but in FIG. 1 is illustrated as an object denoted by reference numeral 3.

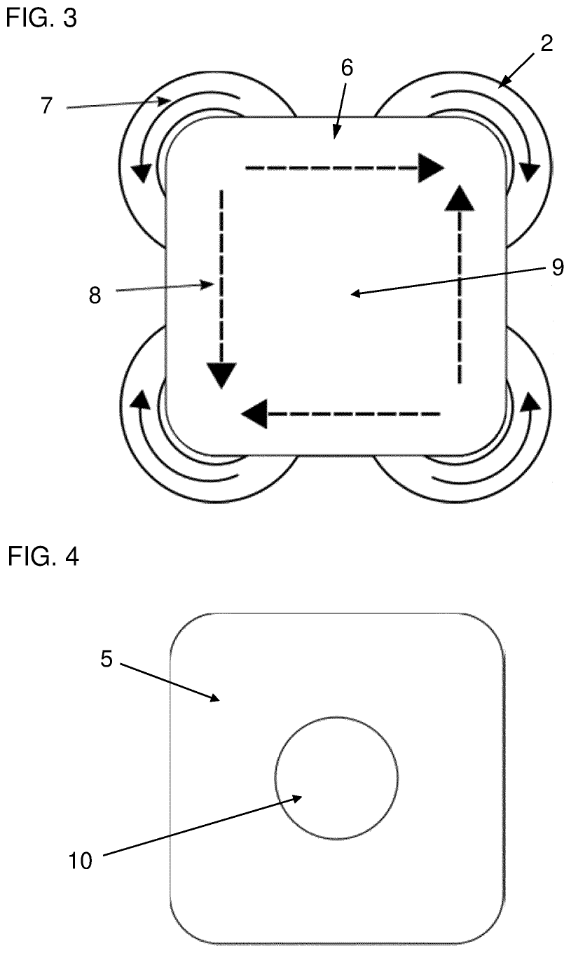

FIG. 3 illustrates via arrows electric current flow directions 7 in windings 4 around magnetic legs 2, as well as the resulting magnetic flux directions 8. It is apparent that windings 4 around adjacently situated magnetic legs 2 have opposite electric current flow directions 7 in each case. This results in the depicted magnetic flux directions 8 in the edge regions of top magnetic plate 6, illustrated here by way of example.

In a middle region 9 (i.e., the center) of each of bottom and top magnetic plates 5, 6, magnetic fluxes 8 largely cancel one another out. Consequently, middle region 9 of each magnetic plate 5, 6 is essentially free of magnetic fields. Because middle region 9 of each magnetic plates 5, 6 thus does not contribute to the functioning of the matrix transformer, middle region 9 of either or both magnetic plates 5, 6 may be omitted (i.e., removed) without impairing the functioning of the matrix transformer.

It is thus possible to introduce a recess 10 that is circular, for example, in the center or middle region 9 of bottom magnetic plate 5, as schematically illustrated in FIG. 4. Ferrite material of body 1, particularly of bottom magnetic plate 5, is thus advantageously saved as well.

As shown in FIG. 1, cooling pin 12, which is connected here in one piece to a solid heat sink 11 strictly by way of example, may be inserted into recess 10. Cooling pin 12 is guided up to a surface of PCB 3, where it forms a cooling surface 13. As cooling pin 12 is guided through a magnetic flux-free region of magnetic plate 5, the cooling pin may advantageously be made of a metal.

Very efficient cooling of a matrix transformer may be achieved in this way, via which it is also possible in particular to increase the power of the matrix transformer.

### LIST OF REFERENCE NUMERALS

1 (soft magnetic) body
2 magnetic leg
3 printed circuit board (PCB)
4 windings (turns)
5 (bottom) magnetic plate
6 (top) magnetic plate
7 electric current flow directions
8 magnetic flux direction
9 middle region or center (magnetic field-free zone)
10 recess
11 heat sink
12 cooling pin
13 cooling surface

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A matrix transformer comprising:
a magnetic core structure having a plurality of magnetic legs and first and second magnetic plates, the magnetic plates being spaced apart from one another and being connected together by the magnetic legs; and
a plurality of electrical current-conductive windings, the windings being respectively wrapped around the magnetic legs, the windings having electric current flow directions which cause magnetic fluxes within the magnetic core structure that cancel out in a middle region of each magnetic plate thereby leaving the middle region of each magnetic plate to be a magnetic field-free zone; and
wherein the first magnetic plate has a recess extending through the middle region of the first magnetic plate within the magnetic field-free zone of the first magnetic plate.

2. The matrix transformer of claim 1 further comprising:
a heat sink having a cooling pin connected thereto, the cooling pin being inserted through the recess.

3. The matrix transformer of claim 1 further comprising:
a printed circuit board (PCB) having openings; and
wherein the body forms a closed magnetic circuit through the openings in the PCB.

4. The matrix transformer of claim 3 wherein:
the magnetic legs respectively extend through the openings in the PCB; and
the first magnetic plate is positioned under a bottom side of the PCB and the second magnetic plate is positioned over a top side of the PCB.

5. The matrix transformer of claim 4 further comprising:
a heat sink having a cooling pin connected thereto, the cooling pin being guided through the recess as far as a surface of the bottom side of the PCB.

6. The matrix transformer of claim 4 wherein:
the magnetic plates are parallel with one another.

7. The matrix transformer of claim 6 wherein:
the magnetic legs are orthogonal to the magnetic plates.

8. The matrix transformer of claim 3 wherein:
the windings are conductive traces or strip conductors of the PCB.

9. The matrix transformer of claim 3 wherein:
the windings are formed, at least in part, from wound wires or cut sheet metal mounted on the PCB.

10. The matrix transformer of claim 1 wherein:
the plurality of windings include four windings.

11. The matrix transformer of claim 1 wherein:
the magnetic core structure is made of a soft magnetic material.

12. The matrix transformer of claim 1 wherein:
the magnetic legs and the magnetic plates are made of ferrite.

13. A matrix transformer comprising:
a body that is made of soft magnetic material and that forms a closed magnetic circuit through openings in at least one printed circuit board (PCB);
a plurality of windings;
the body having magnetic legs and two parallel magnetic plates, the magnetic legs being surrounded by the windings, the magnetic plates being on respective sides of the PCB and being connected to one another by the magnetic legs;
the windings, due to a suitably selected winding direction, forming a magnetic field-free zone in each of the magnetic plates;
a heat sink having a cooling pin connected thereto; and
wherein at least a first one of the magnetic plates has a recess therein within the magnetic field-free zone of the first one of the magnetic plates, and the cooling pin is guided through the recess up to a surface of the PCB.

14. The matrix transformer of claim 13 wherein:
the magnetic legs and the magnetic plates are made of ferrite.

15. The matrix transformer of claim 13 wherein:
the windings are formed by strip conductors of the PCB.

16. The matrix transformer of claim 13 wherein:
the windings are formed, at least in part, from wound wires or cut sheet metal mounted on the PCB.
